(19) United States
(12) Patent Application Publication
(10) Pub. No.: US 2026/0221069 A1
(43) Pub. Date: Jul. 30, 2026

(54) DISPLAY DEVICE

(71) Applicant: Sharp Display Technology Corporation, Kameyama City, Mie (JP)

(72) Inventors: Takafumi MIURA, Sakai City (JP); Masamitsu KOBAYASHI, Sakai City (JP)

(21) Appl. No.: 19/151,632

(22) PCT Filed: Feb. 2, 2023
(86) PCT No.: PCT/JP2023/003362

§ 371 Date: Jul. 29, 2025

(51) Int. Cl. G09G 3/20; G09G 3/32; G09G 3/3225

(52) U.S. Cl. CPC G09G 3/204; G09G 3/2096; G09G 3/32; G09G 3/3225; G09G 2320/0247; G09G 2360/10; G09G 2360/16

(57) ABSTRACT

A display device includes a calculation unit that includes at least one of a motion degree calculation unit, a blur saturation calculation unit, and an enhancement saturation calculation unit, a blur enhancement processing unit that performs blur processing on one of image data of a first-half sub-frame and image data of a second-half sub-frame of a current frame and performs enhancement processing on the other, and a display portion. The blur enhancement processing unit outputs the image data of the first-half sub-frame and the image data of the second-half sub-frame corresponding to pixels whose motion degree is equal to or less than a first threshold value without performing the blur processing or the enhancement processing thereon, outputs one of the image data of the first-half sub-frame and the image data of the second-half sub-frame corresponding to pixels whose blur saturation is equal to or greater than a second threshold value without performing the blur processing thereon, and outputs one of the image data of the first-half sub-frame and the image data of the second-half sub-frame corresponding to pixels whose enhancement saturation is equal to or greater than the second threshold value without performing the enhancement processing thereon.

### TECHNICAL FIELD

The disclosure relates to a display device.

### BACKGROUND ART

In the related art, for example, in a case where an input image data of 60 Hz is displayed on a display panel driven at an operating frequency of 120 Hz, which is twice as high as that of the input image data, in order to improve the display quality, various techniques have been devised. For example, in the case of a display panel driven at the operating frequency of 120 Hz, there has been proposed a method in which image data of a previous frame and image data of a current frame are respectively divided into image data of a first-half sub-frame and image data of a second-half sub-frame, the image data of the first-half sub-frame is subjected to blur processing, and the image data of the second-half sub-frame is subjected to enhancement processing.

### CITATION LIST

### Patent Literature

PTL 1: WO 2007/052441

### SUMMARY

### Technical Problem

However, in the case of the known method described above, since blur processing and enhancement processing are performed regardless of the type of image data, flickering (flicker) is caused by blur processing and enhancement processing performed on a still image. In addition, blur processing or enhancement processing performed on the image data that contains the maximum gray scale value or the minimum gray scale value causes degradation in display quality. As described above, in the case of the above-described known method, there is a problem in that the display quality may be degraded due to blur processing and enhancement processing which are performed even when unnecessary.

An aspect of the disclosure has been made in view of the above problems, and an object thereof is to provide a display device that suppresses degradation of display quality caused by blur processing and enhancement processing.

### Solution to Problem

In order to solve the above-mentioned problem, a display device according to the disclosure includes a display portion configured to perform display based on image data of a first-half sub-frame and image data of a second-half sub-frame, image data of a previous frame and image data of a current frame each including brightness data of a plurality of pixels, the image data of the previous frame and the image data of the current frame each being divided into the image data of the first-half sub-frame and the image data of the second-half sub-frame; a calculation unit including at least one of a motion degree calculation unit configured to calculate a motion degree of the pixels based on the image data of the previous frame and the image data of the current frame, a blur saturation calculation unit configured to calculate blur saturation of the pixels based on the image data of the previous frame and the image data of the current frame, and an enhancement saturation calculation unit configured to calculate enhancement saturation of the pixels based on the image data of the current frame; and a blur enhancement processing unit configured to perform blur processing on one of the image data of the first-half sub-frame and the image data of the second-half sub-frame of the current frame, and perform enhancement processing on the other, in which in a case where the calculation unit includes the motion degree calculation unit, the blur enhancement processing unit is configured to output, without performing the blur processing and the enhancement processing on, the image data of the first-half sub-frame and the image data of the second-half sub-frame corresponding to a pixel having the motion degree equal to or less than a first threshold value among the plurality of pixels, in a case where the calculation unit includes the blur saturation calculation unit, the blur enhancement processing unit is configured to output, without performing the blur processing on, one of the image data of the first-half sub-frame and the image data of the second-half sub-frame corresponding to a pixel having the blur saturation equal to or greater than a second threshold value among the plurality of pixels, and in a case where the calculation unit includes the enhancement saturation calculation unit, the blur enhancement processing unit is configured to output, without performing the enhancement processing on, one of the image data of the first-half sub-frame and the image data of the second-half sub-frame corresponding to a pixel having the enhancement saturation equal to or greater than the second threshold value among the plurality of pixels.

### Advantageous Effects of Disclosure

According to an aspect of the disclosure, a display device that suppresses the degradation of display quality caused by blur processing and enhancement processing can be provided.

### BRIEF DESCRIPTION OF DRAWINGS

FIG. 1 is a diagram illustrating a schematic configuration of a display device according to a first embodiment.

FIG. 2 is a diagram illustrating a schematic configuration of a saturation calculation unit and a motion degree calculation unit provided in an image processing unit of the display device according to the first embodiment.

FIG. 3 is a diagram illustrating a schematic configuration of a blur enhancement processing unit included in the image processing unit of the display device according to the first embodiment.

FIG. 4 is a diagram illustrating a problem that arises when blur processing and enhancement processing are performed on a still image.

FIG. 5 is a diagram illustrating a problem that arises when blur processing or enhancement processing is performed on image data that contains a maximum gray scale value or a minimum gray scale value.

FIG. 6 is a diagram illustrating image data of a first-half sub-frame and image data of a second-half sub-frame output from the blur enhancement processing unit provided in the image processing unit of the display device according to the first embodiment.

FIG. 7 is a diagram illustrating a reason why degradation of display quality caused by blur processing and enhancement processing can be suppressed in the display device according to the first embodiment.

FIG. 8 is a diagram illustrating that display quality is improved by blur processing and enhancement processing when an input image is a moving image in the display device according to the first embodiment.

FIG. 9 is a diagram illustrating an example of the order in which a motion degree, blur saturation, and enhancement saturation are calculated in the image processing unit of the display device according to the first embodiment.

FIG. 10 is a diagram illustrating another example of the order in which the motion degree, the blur saturation, and the enhancement saturation are calculated in the image processing unit of the display device according to the first embodiment.

FIG. 11 is a diagram illustrating still another example of the order in which the motion degree, the blur saturation, and the enhancement saturation are calculated in the image processing unit of the display device according to the first embodiment.

FIG. 12 is a diagram illustrating examples of a process of calculating the motion degree and a process of determining the necessity of blur processing and enhancement processing for each pixel based on the motion degree, which are performed in the image processing unit of the display device according to the first embodiment.

FIG. 13 is a diagram illustrating examples of a process of converting image data of a previous frame into normalized luminance and a process of converting image data of a current frame into normalized luminance, which are performed in the image processing unit of the display device according to the first embodiment.

FIG. 14 is a diagram illustrating examples of a process of performing saturation gray scale processing on normalized luminance of the previous frame and a process of performing saturation gray scale processing on normalized luminance of the current frame, which are performed in the image processing unit of the display device according to the first embodiment.

FIG. 15 is a diagram illustrating examples of a process of obtaining the saturation of the previous frame by performing filter processing and a process of obtaining the saturation of the current frame by performing filter processing, which are performed in the image processing unit of the display device according to the first embodiment.

FIG. 16 is a diagram illustrating examples of a process of calculating the blur saturation and a process of determining the necessity of blur processing for each pixel based on the blur saturation, which are performed in the image processing unit of the display device according to the first embodiment.

FIG. 17 is a diagram illustrating examples of a process of calculating the enhancement saturation and a process of determining the necessity of enhancement processing for each pixel based on the enhancement saturation, which are performed in the image processing unit of the display device according to the first embodiment.

FIG. 18 is a diagram illustrating the presence or absence of blur processing and enhancement processing for each pixel performed in the image processing unit of the display device according to the first embodiment.

FIG. 19 is a diagram illustrating examples of a process of calculating a motion degree and a process of determining the necessity of blur processing and enhancement processing for each pixel based on the motion degree, which are performed in an image processing unit of a display device according to a second embodiment.

FIG. 20 is a diagram illustrating examples of a process of converting image data of a previous frame into normalized luminance and a process of converting image data of a current frame into the normalized luminance, which are performed in the image processing unit of the display device according to the second embodiment.

FIG. 21 is a diagram illustrating examples of a process of performing saturation gray scale processing on the normalized luminance of the previous frame and a process of performing saturation gray scale processing on the normalized luminance of the current frame, which are performed in the image processing unit of the display device according to the second embodiment.

FIG. 22 is a diagram illustrating examples of a process of obtaining saturation of the previous frame by performing filter processing and a process of obtaining saturation of the current frame by performing filter processing, which are performed in the image processing unit of the display device according to the second embodiment.

FIG. 23 is a diagram illustrating examples of a process of calculating blur saturation and a process of determining the necessity of blur processing for each pixel based on the blur saturation, which are performed in the image processing unit of the display device according to the second embodiment.

FIG. 24 is a diagram illustrating examples of a process of calculating enhancement saturation and a process of determining the necessity of enhancement processing for each pixel based on the enhancement saturation, which are performed in the image processing unit of the display device according to the second embodiment.

FIG. 25 is a diagram illustrating the presence or absence of blur processing and enhancement processing for each pixel performed in the image processing unit of the display device according to the second embodiment.

FIG. 26 is a diagram illustrating the reason why degradation of display quality caused by blur processing and enhancement processing can be further suppressed in a display device according to a third embodiment.

FIG. 27 is a diagram illustrating examples of a process of calculating a motion degree, blur saturation, and enhancement saturation and a process of determining the necessity of blur processing and enhancement processing for each pixel based on the calculated values, which are performed in an image processing unit of a display device according to a fourth embodiment.

### DESCRIPTION OF EMBODIMENTS

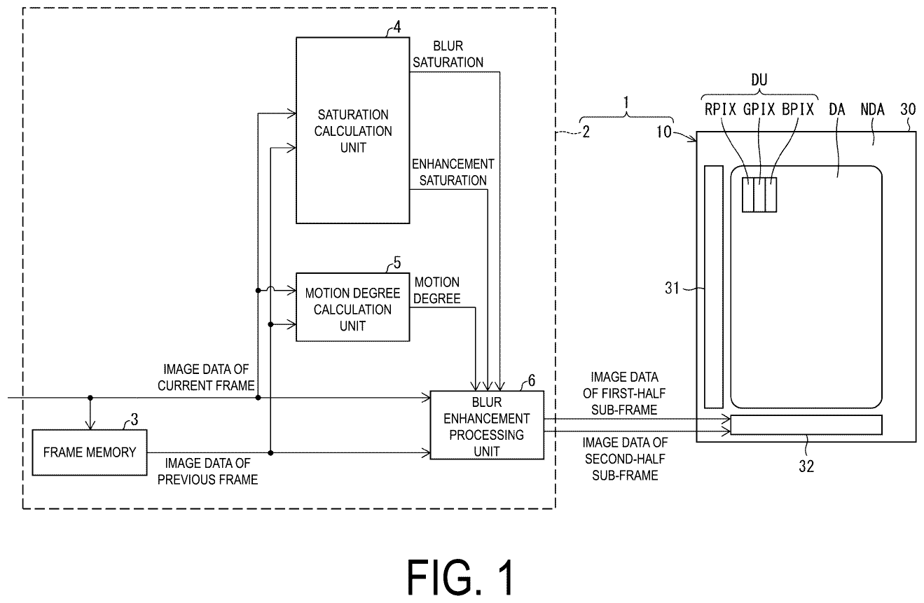

Embodiments of the disclosure will be described with reference to FIGS. 1 to 27 as follows. Hereinafter, for convenience of description, configurations having the same functions as those described in a specific embodiment are denoted by the same reference signs, and descriptions thereof will be omitted.

### First Embodiment

FIG. 1 is a diagram illustrating a schematic configuration of a display device 1 according to a first embodiment.

As illustrated in FIG. 1, the display device 1 includes an image processing unit 2 and a display portion 10.

The display portion 10 includes a substrate 30, a frame region NDA provided on the substrate 30, and a display region DA provided on the substrate 30. A plurality of display units DU are provided in the display region DA of the display portion 10, and each display unit DU includes, for example, a red pixel RPIX, a green pixel GPIX, and a blue pixel BPIX. In the present embodiment, a case will be described as an example in which one display unit DU is composed of the red pixel RPIX, the green pixel GPIX, and the blue pixel BPIX, but the disclosure is not limited thereto. For example, one display unit DU may include, in addition to the red pixel RPIX, the green pixel GPIX, and the blue pixel BPIX, pixels of other colors as well. In the present embodiment, a case will be described as an example in which a scanning-side drive circuit 31 and a data-side drive circuit 32 are provided in the frame region NDA of the display portion 10, but the disclosure is not limited thereto. For example, at least one of the scanning-side drive circuit 31 and the data-side drive circuit 32 may be externally attached to the display portion 10. Note that, as the substrate 30, a flexible substrate such as a resin substrate may be used, or a non-flexible substrate such as a glass substrate may be used.

In the present embodiment, a case will be described as an example in which the red pixel RPIX includes a red light-emitting element, the green pixel GPIX includes a green light-emitting element, the blue pixel BPIX includes a blue light-emitting element, and the display portion 10 is a display portion including a plurality of light-emitting elements, but the disclosure is not limited thereto. For example, the display portion 10 may be a liquid crystal display panel. Note that the light-emitting element may be a light-emitting element including an organic light-emitting layer or a light-emitting element including a light-emitting layer containing quantum dots.

The image processing unit 2 includes a frame memory 3, a saturation calculation unit 4, a motion degree calculation unit 5, and a blur enhancement processing unit 6. Image data of a current frame (N frame: N is a natural number equal to or greater than 2) and image data of a previous frame (N−1 frame) include brightness data of the red pixel RPIX, the green pixel GPIX, and the blue pixel BPIX included in the plurality of display units DU provided in the display region DA of the display portion 10. Note that the brightness data may be a gray scale value or a Y luminance value in YUV data.

As illustrated in FIG. 1, the image data of the current frame is supplied from the outside of the image processing unit 2 to each of the frame memory 3, the saturation calculation unit 4, the motion degree calculation unit 5, and the blur enhancement processing unit 6, and the image data of the previous frame is supplied to each of the saturation calculation unit 4, the motion degree calculation unit 5, and the blur enhancement processing unit 6 via the frame memory 3.

The saturation calculation unit 4 calculates blur saturation and enhancement saturation, and the motion degree calculation unit 5 calculates a motion degree.

The blur enhancement processing unit 6 performs blur processing on one of the image data of a first-half sub-frame and the image data of a second-half sub-frame of the current frame, and performs enhancement processing on the other. The blur enhancement processing unit 6 determines, based on the motion degree, the blur saturation, and the enhancement saturation, whether blur processing is necessary for each pixel and whether enhancement processing is necessary for each pixel. In the present embodiment, a case will be described as an example in which the blur enhancement processing unit 6 performs blur processing on the image data of pixels determined to require blur processing, the blur enhancement processing unit 6 does not perform blur processing on the image data of pixels determined not to require blur processing, and the image data of the first-half sub-frame of the current frame is then output to the data-side drive circuit 32, and the blur enhancement processing unit 6 performs enhancement processing on the image data of pixels determined to require enhancement processing, the blur enhancement processing unit 6 does not perform enhancement processing on the image data of pixels determined not to require enhancement processing, and the image data of the second-half sub-frame of the current frame is then output to the data-side drive circuit 32, but the disclosure is not limited to this. Enhancement processing may be performed on the image data of pixels for which the blur enhancement processing unit 6 determines that enhancement processing is necessary, and enhancement processing may not be performed on the image data of pixels for which the blur enhancement processing unit 6 determines that enhancement processing is not necessary, and the image data of the first-half sub-frame of the current frame may be output to the data-side drive circuit 32. Blur processing may be performed on the image data of pixels for which the blur enhancement processing unit 6 determines that blur processing is necessary, and blur processing may not be performed on the image data of pixels for which the blur enhancement processing unit 6 determines that blur processing is not necessary, and the image data of the second-half sub-frame of the current frame may be output to the data-side drive circuit 32.

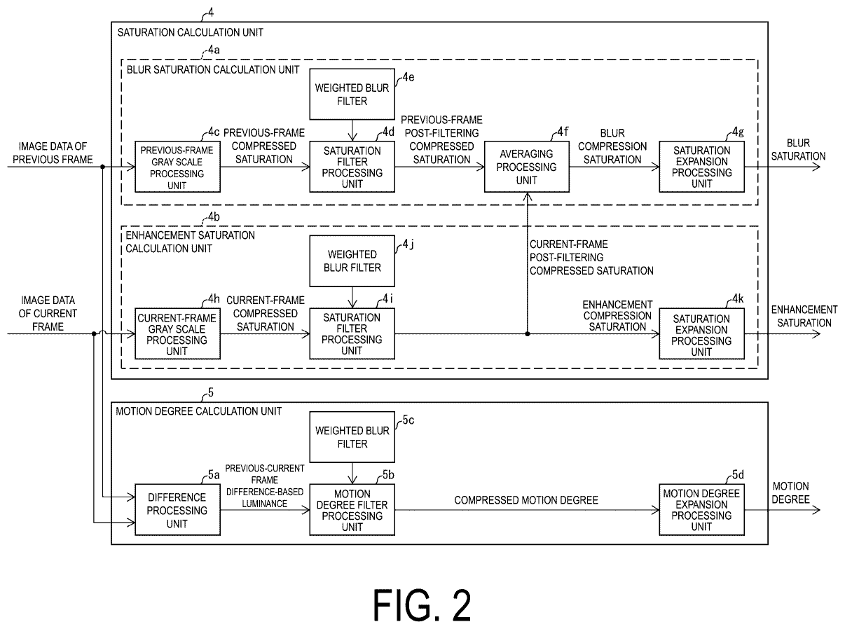

FIG. 2 is a diagram illustrating a schematic configuration of the saturation calculation unit 4 and the motion degree calculation unit 5 provided in the image processing unit 2 of the display device 1 according to the first embodiment.

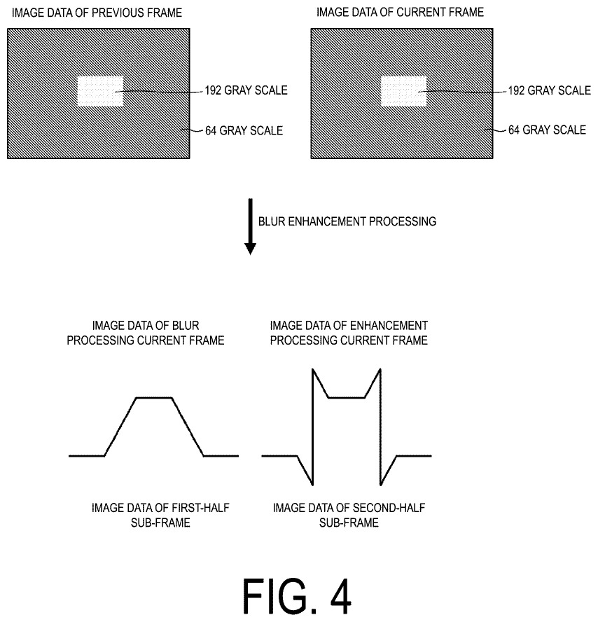

FIG. 4 is a diagram illustrating a problem that arises when blur processing and enhancement processing are performed on a still image.

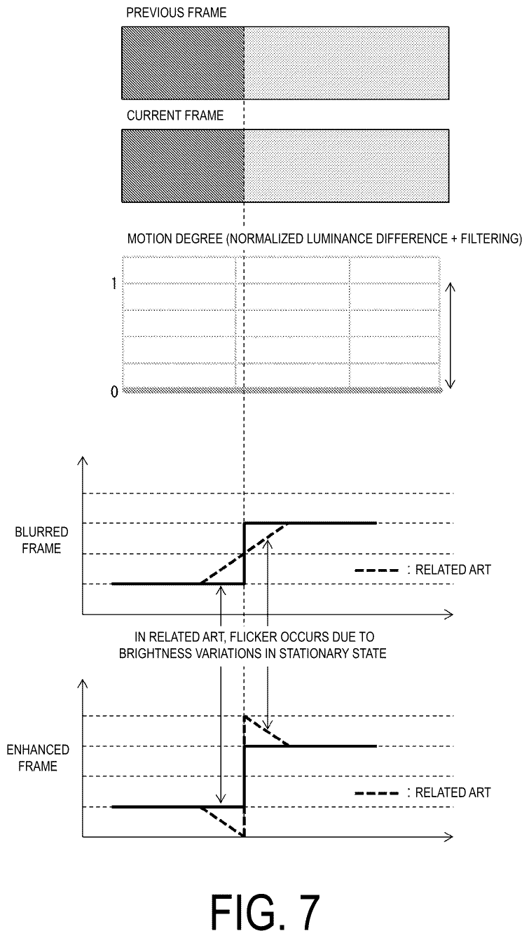

FIG. 7 is a diagram illustrating a reason why degradation of display quality caused by blur processing and enhancement processing can be suppressed in the display device 1 according to the first embodiment.

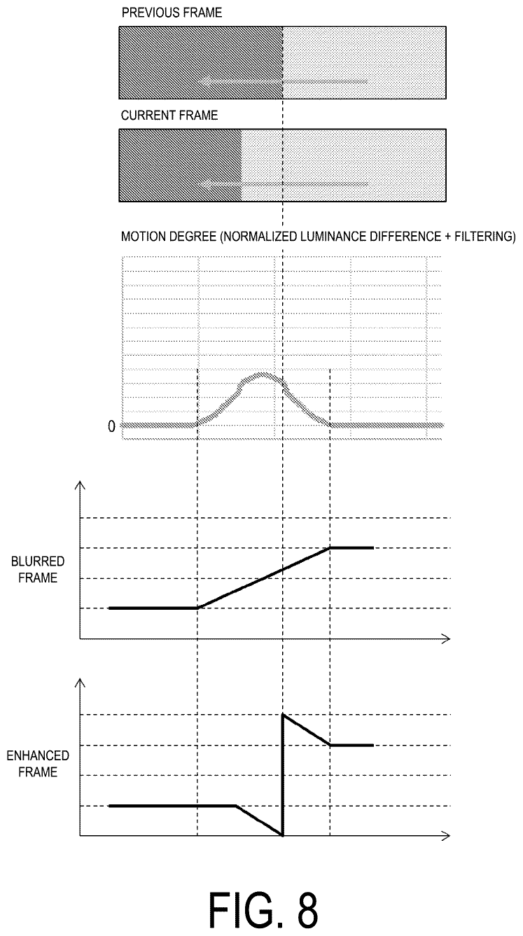

FIG. 8 is a diagram illustrating that the display quality is improved by blur processing and enhancement processing when an input image is a moving image in the display device 1 according to the first embodiment.

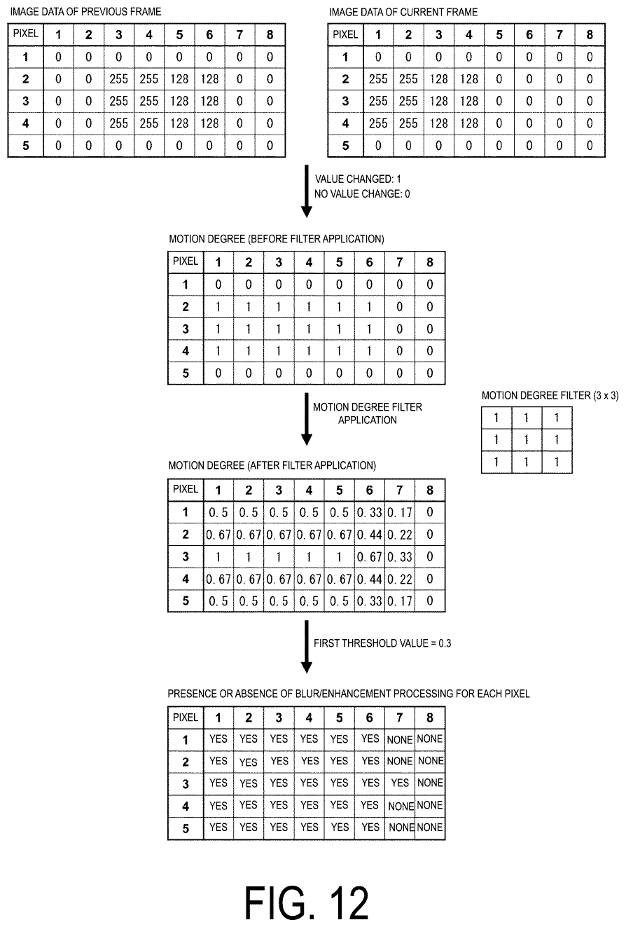

FIG. 12 is a diagram illustrating examples of a process of calculating the motion degree and a process of determining the necessity of blur processing and enhancement processing for each pixel based on the motion degree, which are performed in the image processing unit 2 of the display device 1 according to the first embodiment.

As illustrated in FIG. 2, the saturation calculation unit 4 provided in the image processing unit 2 of the display device 1 includes a blur saturation calculation unit 4a for calculating the blur saturation and an enhancement saturation calculation unit 4b for calculating the enhancement saturation.

In the present embodiment, a case will be described as an example in which the image data of the previous frame supplied to each of the blur saturation calculation unit 4a and the motion degree calculation unit 5 and the image data of the current frame supplied to each of the enhancement saturation calculation unit 4b and the motion degree calculation unit 5 are image data obtained by compressing (thinning) the image data of the pixels of the same color in the adjacent display units DU. For example, adjacent display units DU are composed of a certain specific display unit DU, a display unit DU to the right of the certain specific display unit DU, a display unit DU below the certain specific display unit DU, and a display unit DU to the lower right of the certain specific display unit DU. Compression (thinning) processing may be performed such that the image data of each of four pixels of the same color (for example, four red pixels RPIX) in the four display units DU which are the adjacent display units DU becomes the same image data, for example, the image data of the four pixels is composed of the image data of the certain specific display unit DU. By performing the compression (thinning) processing in this way, the data processing amount in the image processing unit 2 can be reduced. As described above, in the present embodiment, a case has been described as an example in which the image data of the previous frame and the image data of the current frame are subjected to compression (thinning) processing and then supplied to the image processing unit 2, but the disclosure is not limited thereto. For example, at least one of the image data of the previous frame and the image data of the current frame may be supplied to the image processing unit 2 without being subjected to the compression (thinning) processing. In this case, the compression (thinning) processing may be performed inside the image processing unit 2 or the compression (thinning) processing does not necessarily have to be performed.

As illustrated in FIG. 2, the motion degree calculation unit 5 includes a difference processing unit 5a, a motion degree filter processing unit 5b that performs motion degree filter processing using a weighted blur filter 5c, and a motion degree expansion processing unit 5d that derives the motion degree of each pixel from the compressed motion degree that has been subjected to compression (thinning) processing.

FIG. 12 illustrates a part of the image data of the previous frame and a part of the image data of the current frame, and the image data corresponding to each pixel (each of the pixels in the first row and the first column to the pixel in the fifth row and the eighth column) is image data obtained by performing compression (thinning) processing on the image data of four pixels of the same color in the four display units DU which are the adjacent display units DU as described above.

The difference processing unit 5a illustrated in FIG. 2 calculates the difference between the image data of the previous frame and the image data of the current frame in the same pixel as illustrated in FIG. 12, when the difference is not 0, that is, when there is a change in the value of the image data, sets the value of the motion degree to 1, and when the difference is 0, that is, when there is no change in the value of the image data, sets the value of the motion degree to 0, and calculates the motion degree (before filter application) of each pixel corresponding to previous-current frame difference-based luminance.

As illustrated in FIG. 12, the motion degree filter processing unit 5b illustrated in FIG. 2 applies a motion degree filter (3×3) which is the weighted blur filter 5c to the motion degree (before filter application) of each pixel corresponding to the previous-current frame difference-based luminance calculated by the difference processing unit 5a to calculate the motion degree (after filter application) which is the compressed motion degree. When the motion degree is calculated by applying the motion degree filter (3×3), the motion degree is calculated by matching the central portion of the motion degree filter (3×3) with the pixel for which the motion degree after filter application is to be obtained. For example, when the pixel whose motion degree after filter application is to be obtained is the pixel in the first row and first column, the motion degree (after filter application) of the pixel in the first row and first column is 2/4=0.5, when the pixel whose motion degree after filter application is to be obtained is the pixel in the second row and second column, the motion degree (after filter application) of the pixel in the second row and second column is 6/9=0.67, and when the pixel whose motion degree after filter application is to be obtained is the pixel in the third row and fourth column, the motion degree (after filter application) of the pixel in the third row and fourth column is 9/9=1. Note that, in the present embodiment, a case has been described as an example in which the 3×3 motion degree filter is applied, but the disclosure is not limited thereto, and the size of the motion degree filter can be determined as appropriate.

The blur enhancement processing unit 6 illustrated in FIG. 1 can determine the necessity of blur processing and enhancement processing for each pixel based on the motion degree (after filter application) of each pixel illustrated in FIG. 12. For example, when a first threshold value for determining the necessity of blur processing and enhancement processing for each pixel is set to 0.3 in the blur enhancement processing unit 6, the blur enhancement processing unit 6 determines that blur processing and enhancement processing are necessary (“Yes” in FIG. 12) for pixels whose motion degree (after filter application) is greater than the first threshold value, that is, greater than 0.3, while determining that blur processing and enhancement processing are not necessary (“None” in FIG. 12) for pixels whose motion degree (after filter application) is equal to or less than the first threshold value, that is, 0.3 or less. Note that, in the present embodiment, a case will be described as an example in which the necessity of blur processing and enhancement processing for each pixel is determined based on the motion degree (after filter application), but the disclosure is not limited thereto, the necessity of blur processing and enhancement processing for each pixel may be determined based on the motion degree (before filter application).

As described above, in the present embodiment, since the image processing unit 2 includes, in addition to the motion degree calculation unit 5, the blur saturation calculation unit 4a and the enhancement saturation calculation unit 4b as calculation units, the blur enhancement processing unit 6 does not immediately perform blur processing and enhancement processing on pixels determined to require blur processing and enhancement processing based on the motion degree (after filter application), but further determines the necessity of blur processing based on the blur saturation and determines the necessity of enhancement processing based on the enhancement saturation, but the disclosure is not limited thereto. For example, when the image processing unit 2 is driven in a mode in which the motion degree is prioritized or when the image processing unit 2 includes only the motion degree calculation unit 5 as a calculation unit, for pixels for which the blur enhancement processing unit 6 determines that blur processing and enhancement processing are necessary based on the motion degree (after filter application), blur processing may be immediately performed on the image data of the first-half sub-frame of the current frame of the corresponding pixels and enhancement processing may be immediately performed on the image data of the second-half sub-frame of the current frame of the corresponding pixels. On the other hand, for pixels for which the blur enhancement processing unit 6 determines that blur processing and enhancement processing are not necessary based on the motion degree (after filter application), the blur enhancement processing unit 6 immediately outputs the image data of the first-half sub-frame and the image data of the second-half sub-frame of the current frame of the corresponding pixels without performing blur processing and enhancement processing.

FIG. 4 is a diagram illustrating a problem that arises when blur processing and enhancement processing are performed on a still image.

As illustrated in FIG. 4, when the image data of the previous frame and the image data of the current frame are the same image data, that is, when the input image is a still image, there is a problem in that flickering (flicker) is caused due to a luminance difference between the image data of the first-half sub-frame of the current frame and the image data of the second-half sub-frame of the current frame, in a case where, for pixels near the boundary of a gray scale change, the image data of the current frame after blur processing is used as the image data of the first-half sub-frame of the current frame, and the image data of the current frame after enhancement processing is used as the image data of the second-half sub-frame of the current frame.

Therefore, the motion degree calculation unit 5 provided in the display device 1 according to the first embodiment calculates the motion degree based on the luminance difference between the image data of the previous frame and the image data of the current frame in each pixel, and the blur enhancement processing unit 6 outputs the image data of the first-half sub-frame and the image data of the second-half sub-frame of the current frame of the corresponding pixels without performing blur processing and enhancement processing for the pixels whose motion degree are equal to or less than the first threshold value.

As illustrated in FIG. 7, in the display device 1 according to the first embodiment, when the image data of the previous frame and the image data of the current frame are the same image data, that is, when the input image is a still image, the motion degree of pixels near the boundary of the gray scale change is equal to or less than the first threshold value. Therefore, since blur processing and enhancement processing are not performed on the image data of the first-half sub-frame and the image data of the second-half sub-frame of the current frame for these pixels, flickering (flicker) can be suppressed.

On the other hand, in the related art, when the input image is a still image, flickering (flicker) occurred because blur processing and enhancement processing were performed on both the image data of the first-half sub-frame and the image data of the second-half sub-frame of the current frame, for pixels near the boundary of the gray scale change.

As illustrated in FIG. 8, in the display device 1 according to the first embodiment, when the input image is a moving image, the motion degree of pixels near the boundary of the gray scale change in the image data of the previous frame and the motion degree of pixels near the boundary of the gray scale change in the image data of the current frame become greater than the first threshold value. Therefore, blur processing and enhancement processing are performed on the image data of the first-half sub-frame and the image data of the second-half sub-frame of the current frame for these pixels, thereby achieving improved image quality in the moving image.

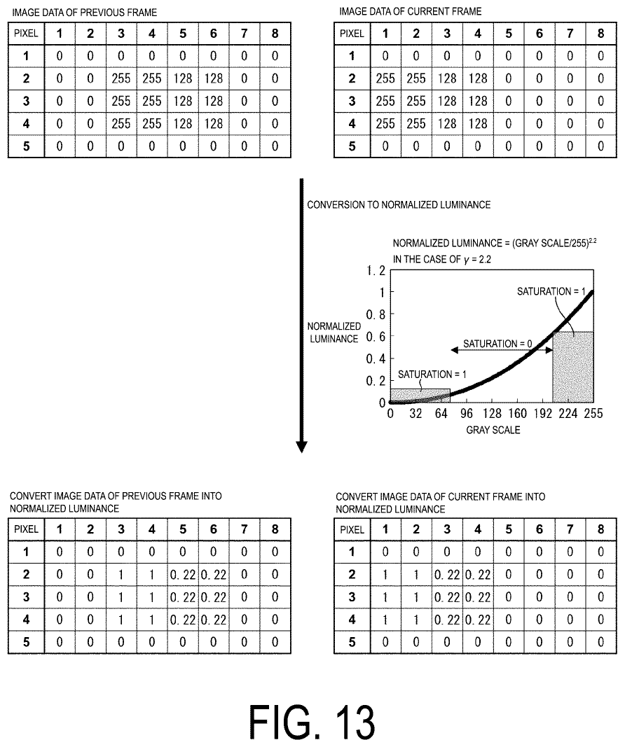

FIG. 13 is a diagram illustrating examples of a process of converting the image data of the previous frame into normalized luminance and a process of converting the image data of the current frame into the normalized luminance, which are performed in the image processing unit 2 of the display device 1 according to the first embodiment.

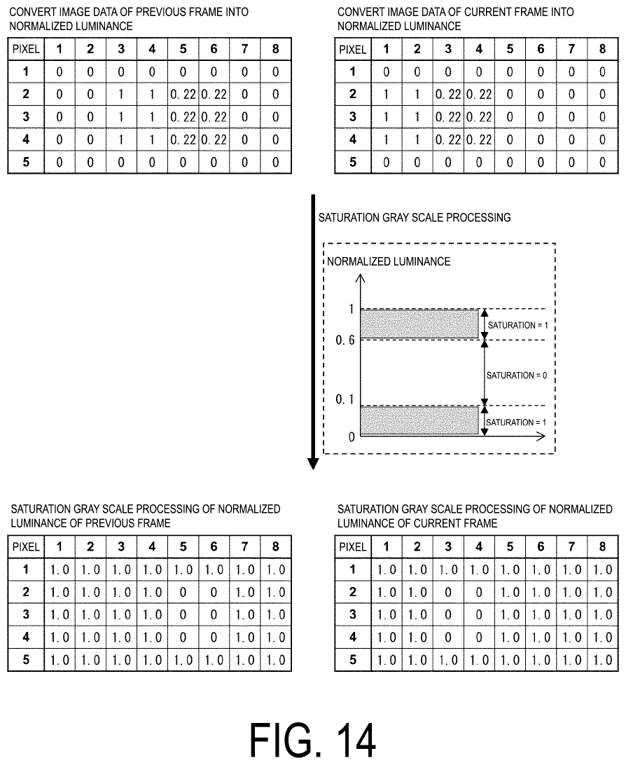

FIG. 14 is a diagram illustrating examples of a process of performing saturation gray scale processing on the normalized luminance of the previous frame and a process of performing the saturation gray scale processing on the normalized luminance of the current frame, which are performed in the image processing unit 2 of the display device 1 according to the first embodiment.

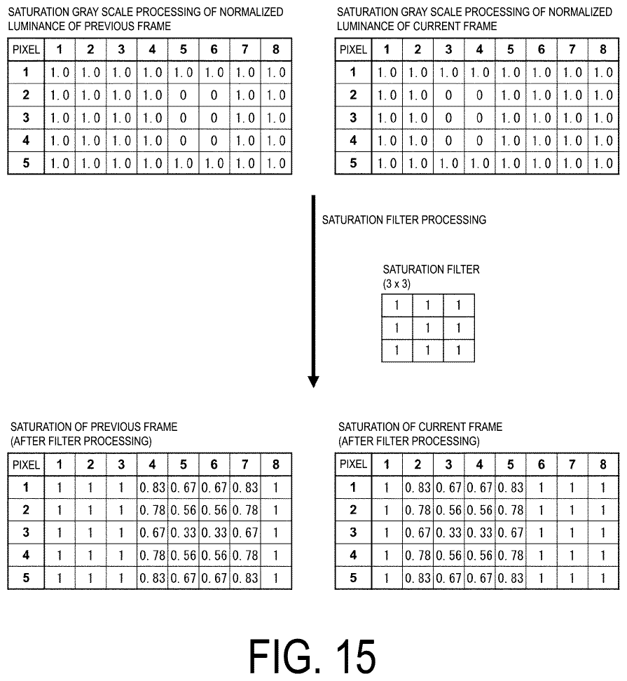

FIG. 15 is a diagram illustrating examples of a process of obtaining the saturation of the previous frame by performing filter processing and a process of obtaining the saturation of the current frame by performing filter processing, which are performed in the image processing unit 2 of the display device 1 according to the first embodiment.

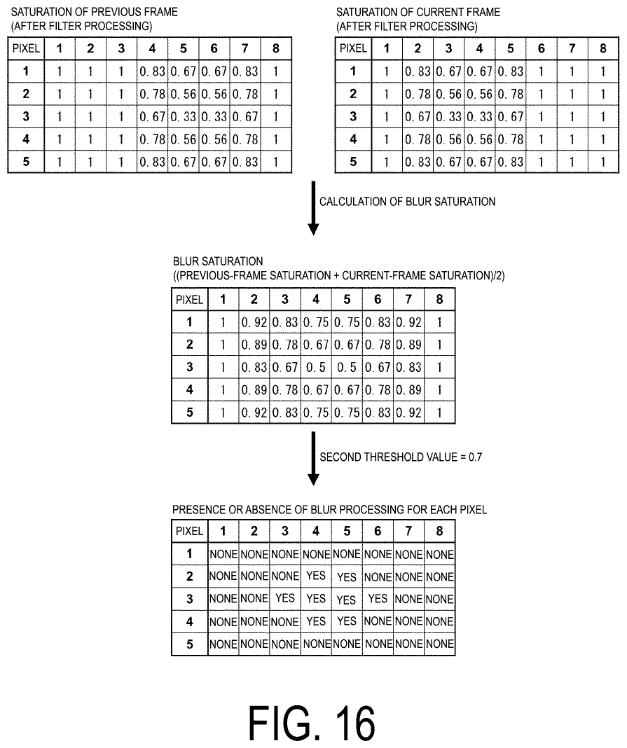

FIG. 16 is a diagram illustrating examples of a process of calculating the blur saturation and a process of determining the necessity of blur processing for each pixel based on the blur saturation, which are performed in the image processing unit 2 of the display device 1 according to the first embodiment.

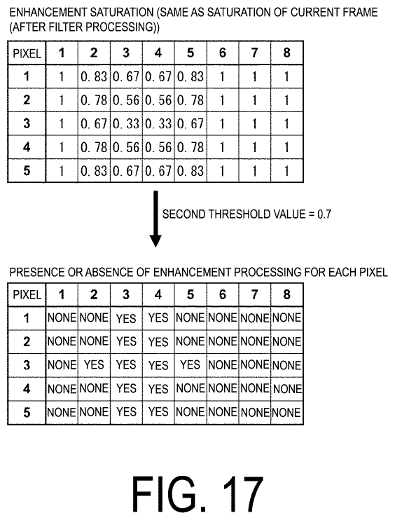

FIG. 17 is a diagram illustrating examples of a process of calculating the enhancement saturation and a process of determining the necessity of enhancement processing for each pixel based on the enhancement saturation, which are performed in the image processing unit 2 of the display device 1 according to the first embodiment.

The normalized luminance calculation unit (not illustrated) of the previous-frame gray scale processing unit 4c provided in the blur saturation calculation unit 4a illustrated in FIG. 2 first converts the gray scale value of each pixel in the image data of the previous frame into normalized luminance based on Equation (1) below, as illustrated in FIG. 13.

$$Normalized luminance = {( gray scale value / maximum gray scale value )}^{γ} \qquad ( 1 )$$

Note that, in the present embodiment, a case will be described as an example in which the maximum gray scale value in Equation (1) above is 255 and the y value is 2.2, but the disclosure is not limited thereto.

Then, as illustrated in FIG. 14, the saturation processing unit (not illustrated) provided in the previous-frame gray scale processing unit 4c performs saturation gray scale processing on the value obtained by converting the gray scale value of each pixel in the image data of the previous frame into the normalized luminance. The saturation processing unit converts a value of the normalized luminance data of the image data of the previous frame into 0 when the value is equal to or greater than a third threshold value and equal to or less than a fourth threshold value, converts the value into 1 when the value is less than the third threshold value or greater than the fourth threshold value, and outputs the converted value as the saturation. In the present embodiment, a case will be described as an example in which the third threshold value is set to 0.1 and the fourth threshold value is set to 0.6, but the disclosure is not limited thereto, and each of the third threshold value and the fourth threshold value can be appropriately set.

As illustrated in FIG. 13, the normalized luminance calculation unit (not illustrated) of the current-frame gray scale processing unit 4h provided in the enhancement saturation calculation unit 4b illustrated in FIG. 2 first converts the gray scale value of each pixel in the image data of the current frame into the normalized luminance based on Equation (1) above.

Then, as illustrated in FIG. 14, a saturation processing unit (not illustrated) provided in the current-frame gray scale processing unit 4h performs saturation gray scale processing on the value obtained by converting the gray scale value of each pixel in the image data of the current frame into the normalized luminance. The saturation processing unit converts a value of the normalized luminance data of the image data of the current frame into 0 when the value is equal to or greater than the third threshold value and equal to or less than the fourth threshold value, converts the value into 1 when the value is less than the third threshold value or greater than the fourth threshold value, and outputs the converted value as the saturation. In the present embodiment, a case will be described as an example in which the third threshold value is set to 0.1 and the fourth threshold value is set to 0.6, but the disclosure is not limited thereto, and each of the third threshold value and the fourth threshold value can be appropriately set.

When the brightness data is a Y luminance value in YUV data, the Y luminance value of each pixel in the image data of the previous frame and the image data of the current frame is converted into the normalized luminance based on Equation (2) below.

$$Normalized luminance = {( Y luminance value / maximum Y luminance value )}^{γ} \qquad ( 2 )$$

Even when the brightness data is the Y luminance value in the YUV data, the third threshold value may be set to 0.1, and the fourth threshold value may be set to 0.6.

As illustrated in FIG. 15, a saturation filter processing unit 4d provided in the blur saturation calculation unit 4a illustrated in FIG. 2 performs saturation filter processing on values obtained by subjecting the normalized luminance of each pixel in the image data of the previous frame to saturation gray scale processing, using a saturation filter (3×3) as a weighted blur filter 4e, thereby obtaining the saturation (after filter processing) of the previous frame.

As illustrated in FIG. 15, a saturation filter processing unit 4i provided in the enhancement saturation calculation unit 4b illustrated in FIG. 2 performs saturation filter processing on values obtained by subjecting the normalized luminance of each pixel in the image data of the current frame to saturation gray scale processing, using the saturation filter (3×3) as a weighted blur filter 4j, thereby obtaining the saturation (after filter processing) of the current frame.

As illustrated in FIG. 2, an averaging processing unit 4f provided in the blur saturation calculation unit 4a performs averaging processing of the saturation (after filter processing) of the previous frame output from the saturation filter processing unit 4d and the saturation (after filter processing) of the current frame output from the saturation filter processing unit 4i to calculate the blur saturation as illustrated in FIG. 16. In the averaging processing, the blur saturation can be calculated by calculating (the saturation of the previous frame (after filter processing)+the saturation of the current frame (after filter processing))/2 for each pixel.

As illustrated in FIG. 2, the blur saturation calculation unit 4a includes a saturation expansion processing unit 4g that derives the blur saturation of each pixel from blur compression saturation that has been subjected to compression (thinning) processing.

The blur enhancement processing unit 6 illustrated in FIG. 1 can determine the necessity of blur processing for each pixel based on the blur saturation of each pixel illustrated in FIG. 16. For example, when a second threshold value for determining the necessity of blur processing for each pixel is set to 0.7 in the blur enhancement processing unit 6, the blur enhancement processing unit 6 determines that blur processing is not necessary (“None” in FIG. 16) for pixels whose blur saturation is equal to or greater than the second threshold value, that is, 0.7 or greater, while determining that blur processing is necessary (“Yes” in FIG. 16) for pixels whose blur saturation is less than the second threshold value, that is, less than 0.7. Note that, in the present embodiment, as illustrated in FIG. 16, a case is described as an example in which the necessity of blur processing for each pixel is determined based on the blur saturation calculated from the saturation (after filter processing) of the previous frame and the saturation (after filter processing) of the current frame, but the disclosure is not limited thereto, and the necessity of blur processing for each pixel may also be determined based on the blur saturation calculated from the value obtained by subjecting the normalized luminance of the previous frame to saturation gray scale processing and the value obtained by subjecting the normalized luminance of the current frame to saturation gray scale processing.

As described above, in the present embodiment, since the image processing unit 2 includes the motion degree calculation unit 5 and the enhancement saturation calculation unit 4b in addition to the blur saturation calculation unit 4a as calculation units, the blur enhancement processing unit 6 does not immediately perform blur processing and enhancement processing on pixels determined to require blur processing and enhancement processing based on the motion degree (after filter application), further, determines the necessity of blur processing based on the blur saturation, but the disclosure is not limited thereto. For example, in a case where the image processing unit 2 is driven in a mode that prioritizes the blur saturation, or in a case where the image processing unit 2 includes, as a calculation unit, only the blur saturation calculation unit 4a, blur processing may be immediately performed on the image data of the first-half sub-frame of the current frame corresponding to pixels for which the blur enhancement processing unit 6 determines, based on the blur saturation, that blur processing is necessary, and for pixels for which the blur enhancement processing unit 6 determines, based on the blur saturation, that blur processing and enhancement processing are not necessary, the image data of the first-half sub-frame of the current frame of the corresponding pixels may be immediately output without performing blur processing.

In the enhancement saturation calculation unit 4b illustrated in FIG. 2, as illustrated in FIG. 17, the saturation (after filter processing) of the current frame output from the saturation filter processing unit 4i becomes the enhancement saturation. The enhancement saturation calculation unit 4b includes a saturation expansion processing unit 4k that derives the enhancement saturation of each pixel from enhancement compression saturation subjected to the compression (thinning) processing.

The blur enhancement processing unit 6 illustrated in FIG. 1 can determine the necessity of enhancement processing for each pixel based on the enhancement saturation of each pixel illustrated in FIG. 17. For example, when the second threshold value for determining the necessity of the enhancement processing for each pixel is set to 0.7 in the blur enhancement processing unit 6, the blur enhancement processing unit 6 determines that enhancement processing is not necessary (“None” in FIG. 17) for pixels having the enhancement saturation equal to or greater than the second threshold value, that is, 0.7 or greater, while determining that blur processing is necessary (“Yes” in FIG. 17) for pixels having the enhancement saturation less than the second threshold value, that is, less than 0.7. Note that, in the present embodiment, as illustrated in FIG. 17, a case is described as an example in which the necessity of enhancement processing for each pixel is determined based on the enhanced saturation, which is the saturation (after filter processing) of the current frame, but the disclosure is not limited thereto, and the value obtained by subjecting the normalized luminance of the current frame to saturation gray scale processing may be used as the enhancement saturation, and the necessity of enhancement processing for each pixel may be determined based on the value obtained by subjecting the normalized luminance of the current frame to saturation gray scale processing.

As described above, in the present embodiment, since the image processing unit 2 includes the blur saturation calculation unit 4a and the motion degree calculation unit 5 in addition to the enhancement saturation calculation unit 4b as calculation units, the blur enhancement processing unit 6 does not immediately perform blur processing and enhancement processing on pixels determined to require blur processing and enhancement processing based on the motion degree (after filter application), but further determines the necessity of enhancement processing based on the enhancement saturation, but the disclosure is not limited thereto. For example, in a case where the image processing unit 2 is driven in a mode that prioritizes enhancement saturation, or in a case where the image processing unit 2 includes, as a calculation unit, only the enhancement saturation calculation unit 4b, for pixels that the blur enhancement processing unit 6 determines to require enhancement processing based on the enhancement saturation, enhancement processing on the image data of the second-half sub-frame of the current frame of the corresponding pixels may be performed immediately, and for pixels that the blur enhancement processing unit 6 determines need not to require enhancement processing based on the enhancement saturation, the image data of the second-half sub-frame of the current frame of the corresponding pixels may be output immediately without performing enhancement processing.

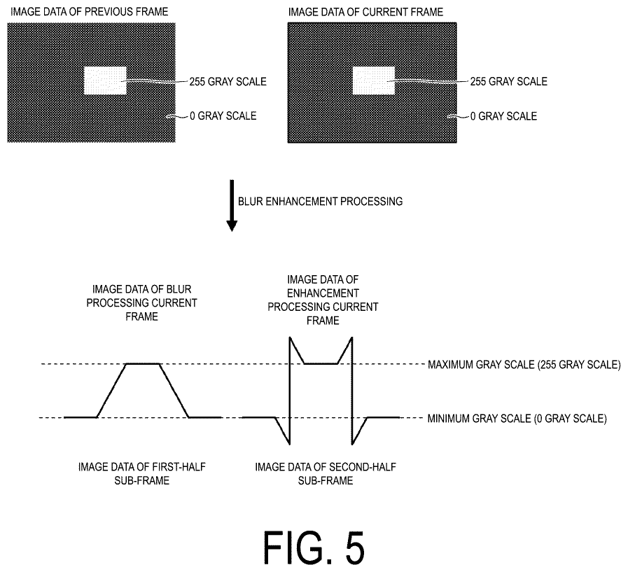

FIG. 5 is a diagram illustrating a problem that arises when blur processing or enhancement processing is performed on the image data including the maximum gray scale value or the minimum gray scale value.

As illustrated in FIG. 5, when the input image is a moving image having the maximum gray scale value (for example, a gray scale value of 255) or the minimum gray scale value (for example, a gray scale value of 0), there is a problem in that degradation in display quality is caused in a case where, for pixels near the boundary of the gray scale change in each of the image data of the previous frame and the image data of the current frame, the image data of the current frame after blur processing is used as the image data of the first-half sub-frame of the current frame, and the image data of the current frame after enhancement processing is used as the image data of the second-half sub-frame of the current frame.

Therefore, the blur saturation calculation unit 4a provided in the display device 1 of the first embodiment calculates the blur saturation of each pixel based on the image data of the previous frame and the image data of the current frame, and the blur enhancement processing unit 6 outputs the image data of the first-half sub-frame of the current frame of the corresponding pixels without performing blur processing for the pixels whose blur saturation is equal to or greater than the second threshold value, and the enhancement saturation calculation unit 4b calculates the enhancement saturation of each pixel based on the image data of the current frame, and the blur enhancement processing unit 6 outputs the image data of the second-half sub-frame of the current frame of the corresponding pixels without performing blur processing for pixels whose enhancement saturation is equal to or greater than the second threshold value. Therefore, the display device 1 in which degradation of display quality caused by blur processing and enhancement processing is suppressed can be achieved.

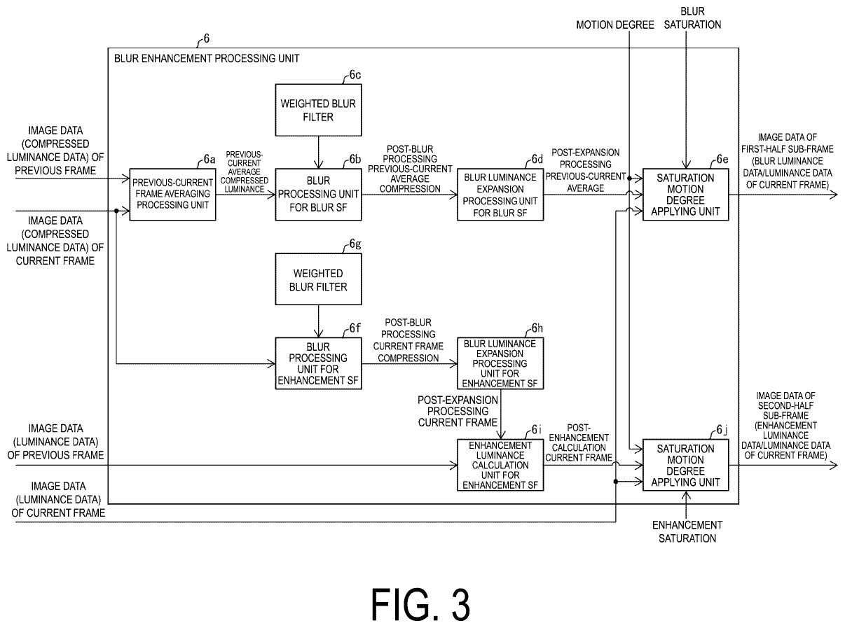

FIG. 3 is a diagram illustrating a schematic configuration of the blur enhancement processing unit 6 provided in the image processing unit 2 of the display device 1 according to the first embodiment.

As illustrated in FIG. 3, in the blur enhancement processing unit 6, a portion for outputting the image data of the first-half sub-frame of the current frame includes a previous-current frame averaging processing unit 6a, a blur processing unit 6b for blur SF that performs filter processing using a weighted blur filter 6c, a blur luminance expansion processing unit 6d for blur SF, and a saturation motion degree applying unit 6e for determining whether or not to apply blur processing based on the motion degree and the blur saturation, and a portion for outputting the image data of the second-half sub-frame of the current frame includes a blur processing unit 6f for enhancement SF that performs filter processing using a weighted blur filter 6g, a blur luminance expansion processing unit 6h for enhancement SF, an enhancement luminance calculation unit 6i for enhancement SF, and a saturation motion degree applying unit 6j for determining whether or not to apply enhancement processing based on the motion degree and the enhancement saturation.

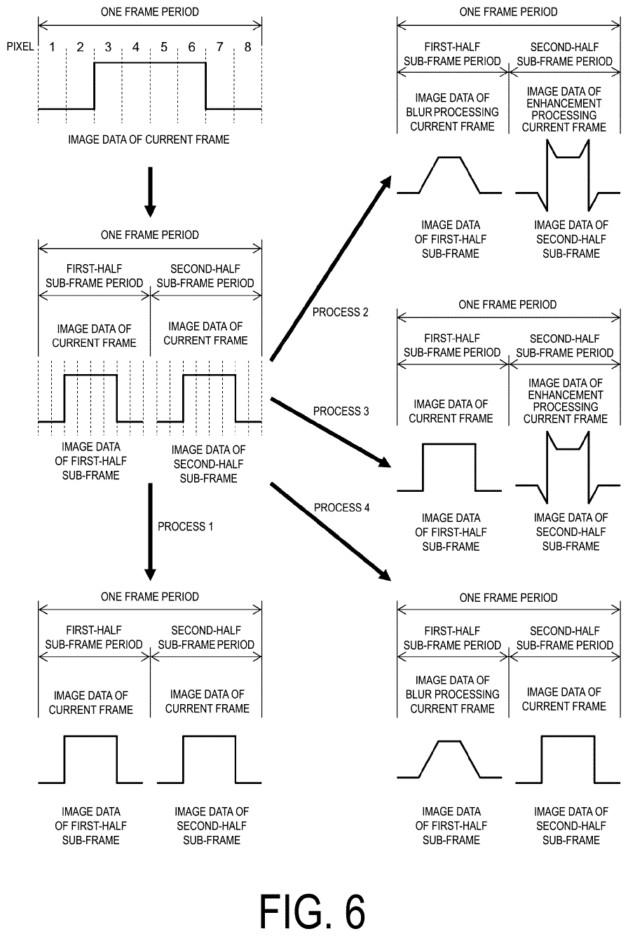

FIG. 6 is a diagram illustrating the image data of the first-half sub-frame and the image data of the second-half sub-frame output from the blur enhancement processing unit 6 provided in the image processing unit 2 of the display device 1 according to the first embodiment.

In the present embodiment, the blur enhancement processing unit 6 illustrated in FIG. 3 outputs the image data of the first-half sub-frame and the image data of the second-half sub-frame corresponding to pixels whose motion degree is equal to or less than the first threshold value without performing blur processing and enhancement processing, as in Process 1 illustrated in FIG. 6, and for the image data of the first-half sub-frame and the image data of the second-half sub-frame corresponding to pixels whose motion degree is greater than the first threshold value and whose blur saturation and enhancement saturation are each equal to or greater than the second threshold value, the data is also output without performing blur processing and enhancement processing, as in Process 1 illustrated in FIG. 6. In addition, the blur enhancement processing unit 6 illustrated in FIG. 3 performs blur processing and enhancement processing on the image data of the first-half sub-frame and the image data of the second-half sub-frame corresponding to pixels whose motion degree is greater than the first threshold value, and each of the blur saturation and the enhancement saturation is less than the second threshold value, as in Process 2 illustrated in FIG. 6. For the image data of the first-half sub-frame and the image data of the second-half sub-frame corresponding to pixels whose motion degree is greater than the first threshold value, the blur saturation is equal to or less than the second threshold value, and the enhancement saturation is less than the second threshold value, only enhancement processing is performed on the image data of the second-half sub-frame, as in Process 3 illustrated in FIG. 6. Further, for the image data of the first-half sub-frame and the image data of the second-half sub-frame corresponding to pixels whose motion degree is greater than the first threshold value, the enhancement saturation is equal to or less than the second threshold value, and the blur saturation is less than the second threshold value, only enhancement processing is performed on the image data of the first-half sub-frame, as in Process 4 illustrated in FIG. 6.

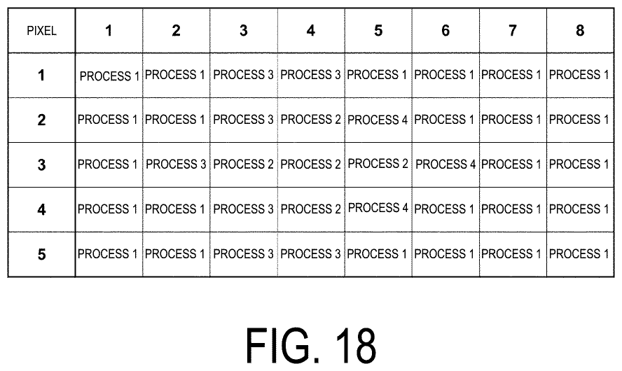

FIG. 18 is a diagram illustrating the presence or absence of blur processing and enhancement processing for each pixel performed in the image processing unit 2 of the display device 1 according to the first embodiment.

As illustrated in FIG. 18, in the blur enhancement processing unit 6 of the present embodiment, any one of Process 1, Process 2, Process 3, and Process 4 illustrated in FIG. 6 is performed for each pixel.

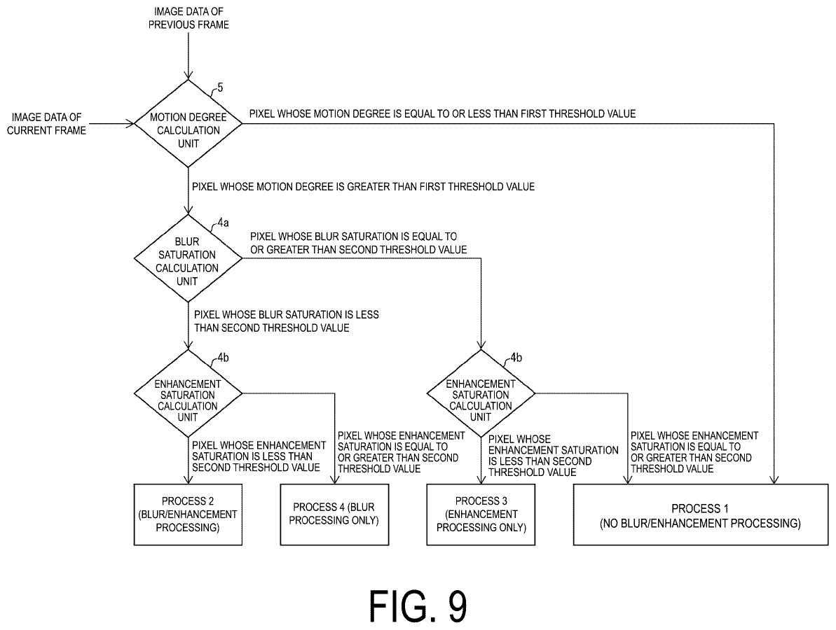

FIG. 9 is a diagram illustrating an example of the order in which the motion degree, the blur saturation, and the enhancement saturation are calculated in the image processing unit 2 of the display device 1 according to the first embodiment.

As illustrated in FIG. 2, the image processing unit 2 of the display device 1 may include a motion degree calculation unit 5, a blur saturation calculation unit 4a, and an enhancement saturation calculation unit 4b, as illustrated in FIG. 9, the motion degree calculation unit 5 may calculate the motion degree of each of a plurality of pixels based on the image data of the previous frame and the image data of the current frame, and the blur saturation calculation unit 4a and the enhancement saturation calculation unit 4b may be configured to respectively calculate the blur saturation and enhancement saturation only for pixels whose motion degree is greater than the first threshold value.

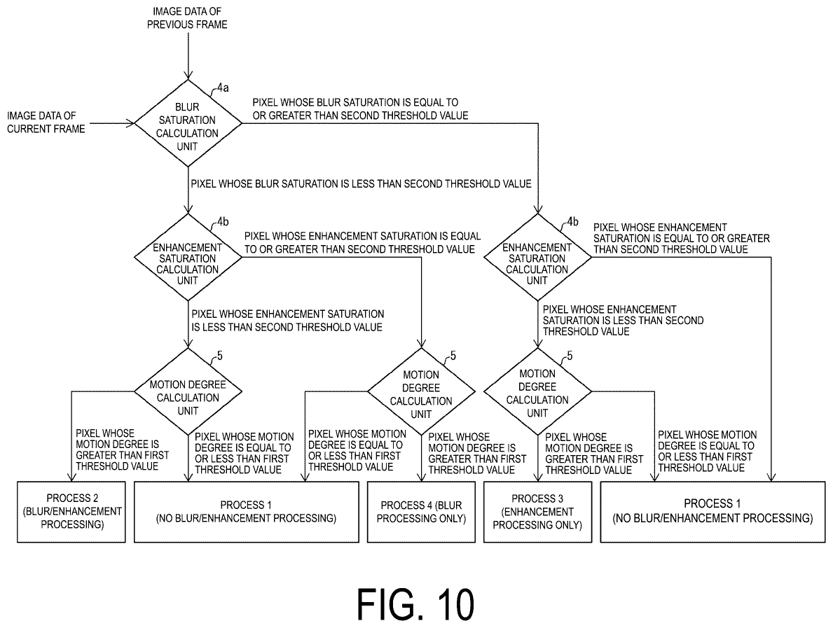

FIG. 10 is a diagram illustrating another example of the order in which the motion degree, the blur saturation, and the enhancement saturation are calculated in the image processing unit 2 of the display device 1 according to the first embodiment.

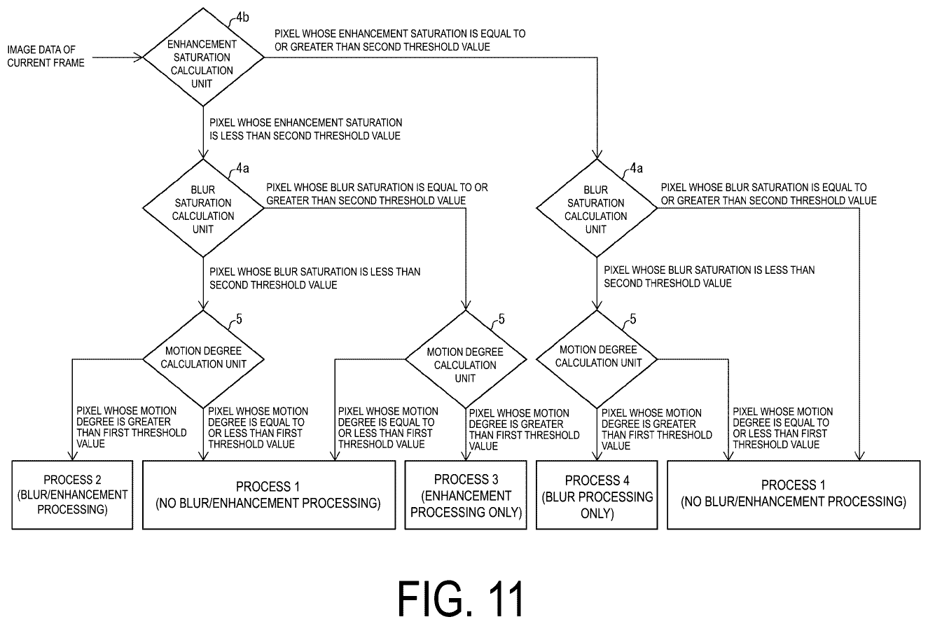

FIG. 11 is a diagram illustrating still another example of the order of calculating the motion degree, the blur saturation, and the enhancement saturation in the image processing unit 2 of the display device 1 according to the first embodiment.

As illustrated in FIG. 2, the image processing unit 2 of the display device 1 may include the motion degree calculation unit 5, the blur saturation calculation unit 4a, and the enhancement saturation calculation unit 4b, as illustrated in FIGS. 10 and 11. The blur saturation calculation unit 4a may calculate the blur saturation of each of the plurality of pixels based on the image data of the previous frame and the image data of the current frame, and the enhancement saturation calculation unit 4b may calculate the enhancement saturation of each of the plurality of pixels based on the image data of the current frame. The motion degree calculation unit 5 may be configured to calculate the motion degree only for pixels in which at least one of the blur saturation and the enhancement saturation is less than the second threshold value.

### Second Embodiment

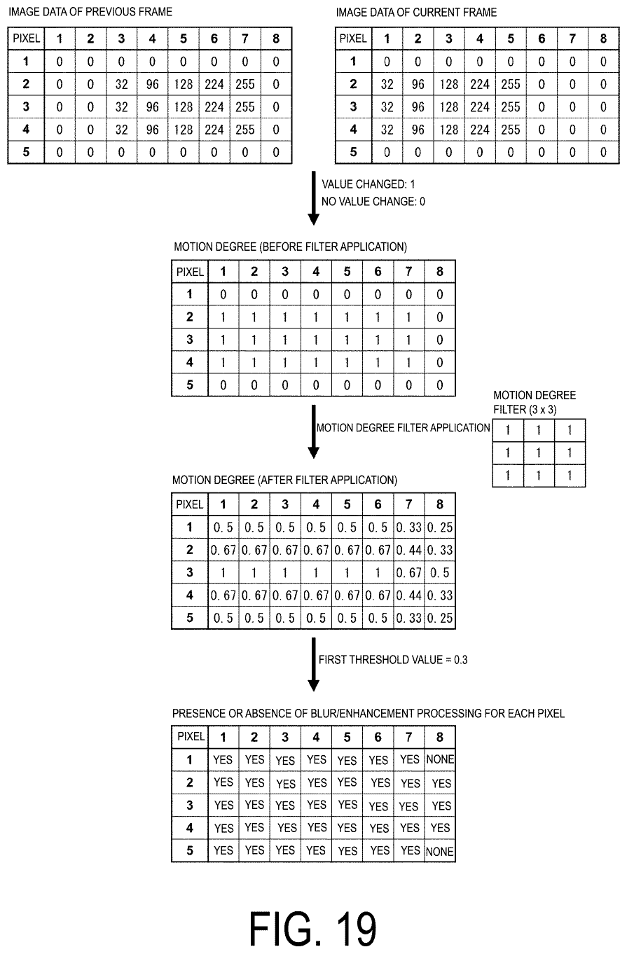

Next, a second embodiment according to the disclosure will be described with reference to FIGS. 19 to 25. A display device of the present embodiment is different from the display device 1 described in the first embodiment in that saturation gray scale processing performed by a saturation processing unit (not illustrated) of a previous-frame gray scale processing unit 4c and the saturation processing unit (not illustrated) of a current-frame gray scale processing unit 4h provided in a display device of the present embodiment is processed so as to include 0<saturation<1 in addition to 1 or 0. The other details are as described in the first embodiment. For convenience of description, members having the same functions as those illustrated in the drawings according to the first embodiment are denoted by the same reference numerals and signs, and descriptions thereof will be omitted.

FIG. 19 is a diagram illustrating examples of a process of calculating a motion degree and a process of determining the necessity of blur processing and enhancement processing for each pixel based on the motion degree, which are performed in an image processing unit of the display device according to the second embodiment.

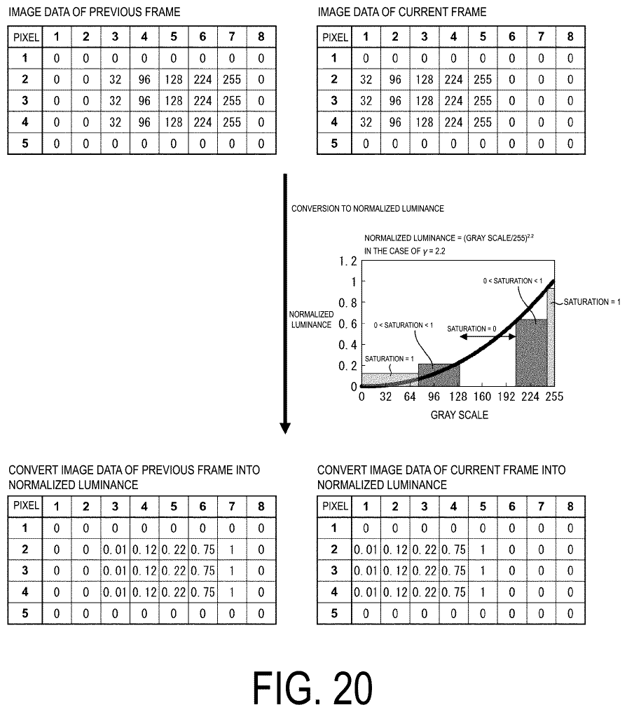

FIG. 20 is a diagram illustrating examples of a process of converting image data of a previous frame into normalized luminance and a process of converting image data of a current frame into the normalized luminance, which are performed in the image processing unit of the display device according to the second embodiment.

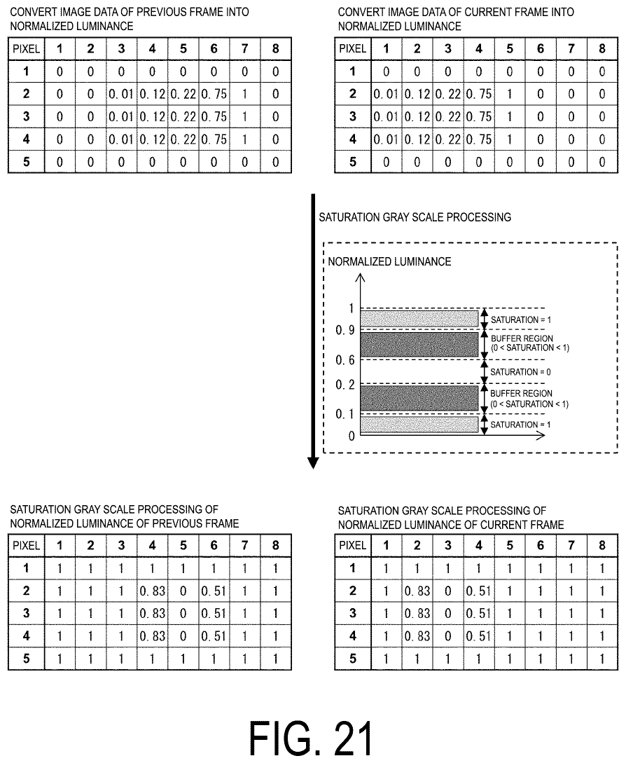

FIG. 21 is a diagram illustrating examples of a process of performing saturation gray scale processing on the normalized luminance of the previous frame and a process of performing saturation gray scale processing on the normalized luminance of the current frame, which are performed in the image processing unit of the display device according to the second embodiment.

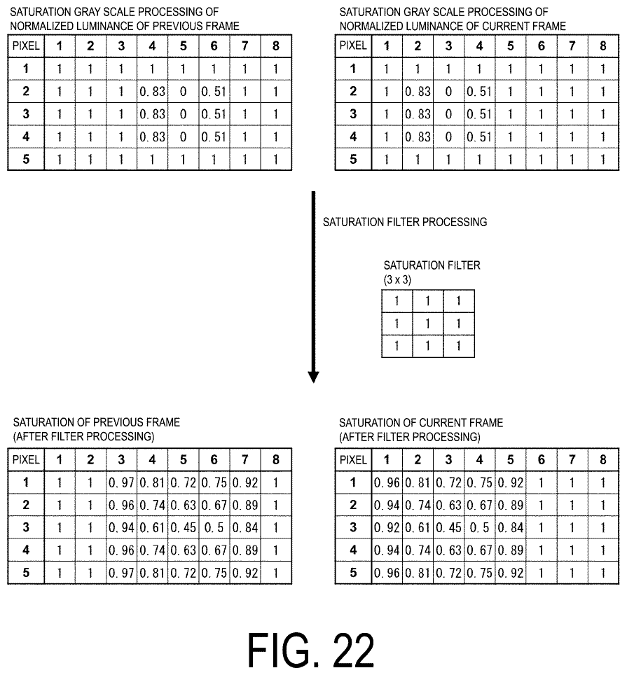

FIG. 22 is a diagram illustrating examples of a process of obtaining saturation of the previous frame by performing filter processing and a process of obtaining saturation of the current frame by performing filter processing, which are performed in the image processing unit of the display device according to the second embodiment.

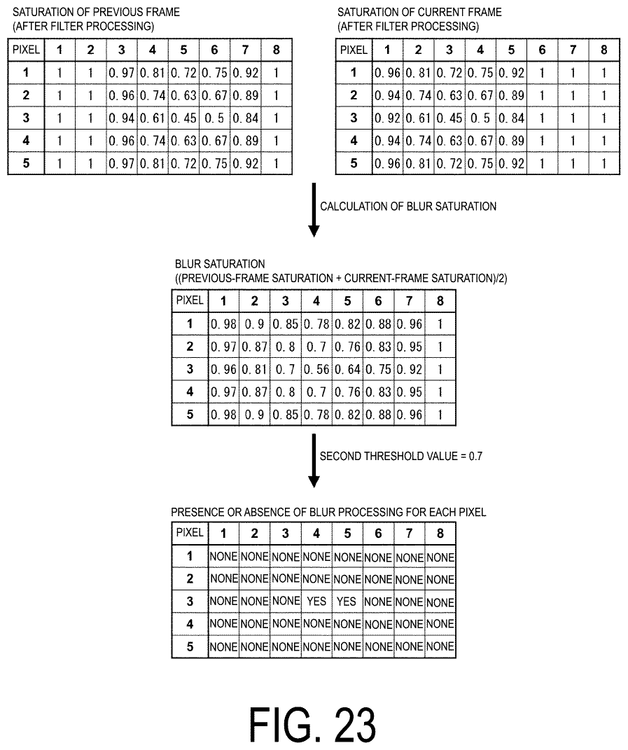

FIG. 23 is a diagram illustrating examples of a process of calculating blur saturation and a process of determining the necessity of blur processing for each pixel based on the blur saturation, which are performed in the image processing unit of the display device according to the second embodiment.

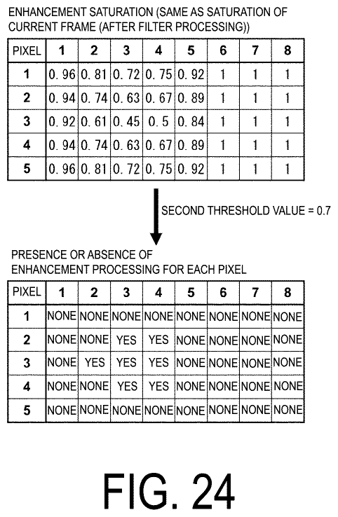

FIG. 24 is a diagram illustrating examples of a process of calculating enhancement saturation and a process of determining the necessity of enhancement processing for each pixel based on the enhancement saturation, which are performed in the image processing unit of the display device according to the second embodiment.

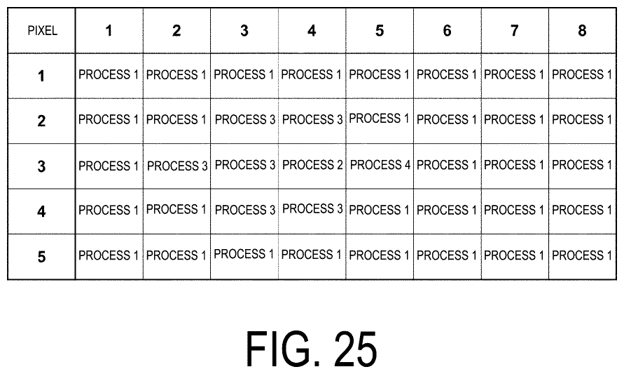

FIG. 25 is a diagram illustrating the presence or absence of blur processing and enhancement processing for each pixel performed in the image processing unit of the display device according to the second embodiment.

Since the processes illustrated in FIGS. 19 and 20 are the same as the processes described based on FIGS. 12 and 13 in the first embodiment, descriptions thereof will be omitted.

As illustrated in FIG. 20, a normalized luminance calculation unit (not illustrated) of the previous-frame gray scale processing unit 4c provided in a blur saturation calculation unit 4a provided in the display device of the present embodiment first converts a gray scale value of each pixel in the image data of the previous frame into the normalized luminance based on Equation (1) below.

$$Normalized luminance = {( gray scale value / maximum gray scale value )}^{γ} \qquad ( 1 )$$

Note that, in the present embodiment, a case will be described as an example in which the maximum gray scale value in Equation (1) above is 255 and the y value is 2.2, but the disclosure is not limited thereto.

Then, as illustrated in FIG. 21, the saturation processing unit (not illustrated) provided in the previous-frame gray scale processing unit 4c provided in the display device of the present embodiment performs saturation gray scale processing on the value obtained by converting the gray scale value of each pixel in the image data of the previous frame into the normalized luminance. The saturation processing unit converts the value of normalized luminance data of the image data of the previous frame into 0 when the value is equal to or greater than a fifth threshold value and equal to or less than a sixth threshold value (0.2<normalized luminance≤0.6 in the present embodiment). When the value is less than the fifth threshold value and equal to or greater than a seventh threshold value (0.1≤normalized luminance<0.2 in the present embodiment) and when the value is greater than the sixth threshold value and equal to or less than an eighth threshold value (0.6<normalized luminance<0.9 in the present embodiment), the saturation processing unit converts the value into a value greater than 0 and less than 1. When the value is less than the seventh threshold value or greater than the eighth threshold value (0.1>normalized luminance, 0.9<normalized luminance in the present embodiment), the saturation processing unit converts the value into 1.

As illustrated in FIG. 20, the normalized luminance calculation unit (not illustrated) of the current-frame gray scale processing unit 4h provided in the enhancement saturation calculation unit 4b provided in the display device of the present embodiment, first converts the gray scale value of each pixel in the image data of the current frame into the normalized luminance based on Equation (1) above.

Then, as illustrated in FIG. 21, a saturation processing unit (not illustrated) provided in the current-frame gray scale processing unit 4h performs saturation gray scale processing on the value obtained by converting the gray scale value of each pixel in the image data of the current frame into the normalized luminance. The saturation processing unit converts the value of the normalized luminance data of the image data of the current frame into 0 when the value is equal to or greater than the fifth threshold value and equal to or less than the sixth threshold value (0.2<normalized luminance≤0.6 in the present embodiment). When the value is less than the fifth threshold value and equal to or greater than the seventh threshold value (0.1≤normalized luminance<0.2 in the present embodiment), and when the value is greater than the sixth threshold value and equal to or less than the eighth threshold value (0.6<normalized luminance≤0.9 in the present embodiment), the saturation processing unit converts the value into a value greater than 0 and less than 1. When the value is less than the seventh threshold value or greater than the eighth threshold value (0.1>normalized luminance, 0.9<normalized luminance in the present embodiment), the saturation processing unit converts the value into 1.

In the present embodiment, a case will be described as an example in which the fifth threshold value is set to 0.2, the sixth threshold value is set to 0.6, the seventh threshold value is set to 0.1, and the eighth threshold value is set to 0.9, but, the disclosure is not limited thereto, and each of the fifth threshold value, the sixth threshold value, the seventh threshold value, and the eighth threshold value can be appropriately set.

When brightness data is a Y luminance value in YUV data, the Y luminance value of each pixel in the image data of the previous frame and the image data of the current frame is converted into the normalized luminance based on Equation (2) below.

$$Normalized luminance = {( Y luminance value / maximum Y luminance value )}^{γ} \qquad ( 2 )$$

Also, in a case where the brightness data is the Y luminance value in the YUV data, the fifth threshold value may be set to 0.2, the sixth threshold value may be set to 0.6, the seventh threshold value may be set to 0.1, and the eighth threshold value may be set to 0.9.

Since the processes illustrated in FIGS. 22, 23, and 24 are the same as the processes described based on FIGS. 15, 16, and 17 in the first embodiment, and descriptions thereof will be omitted.

As illustrated in FIG. 25, in a blur enhancement processing unit 6 of the present embodiment, any one of Process 1, Process 2, Process 3, and Process 4 illustrated in FIG. 6 is performed for each pixel.

According to the display device of the present embodiment, since the blur saturation and the enhancement saturation can be obtained more finely, the degradation of display quality caused by blur processing and enhancement processing can be further suppressed.

### Third Embodiment

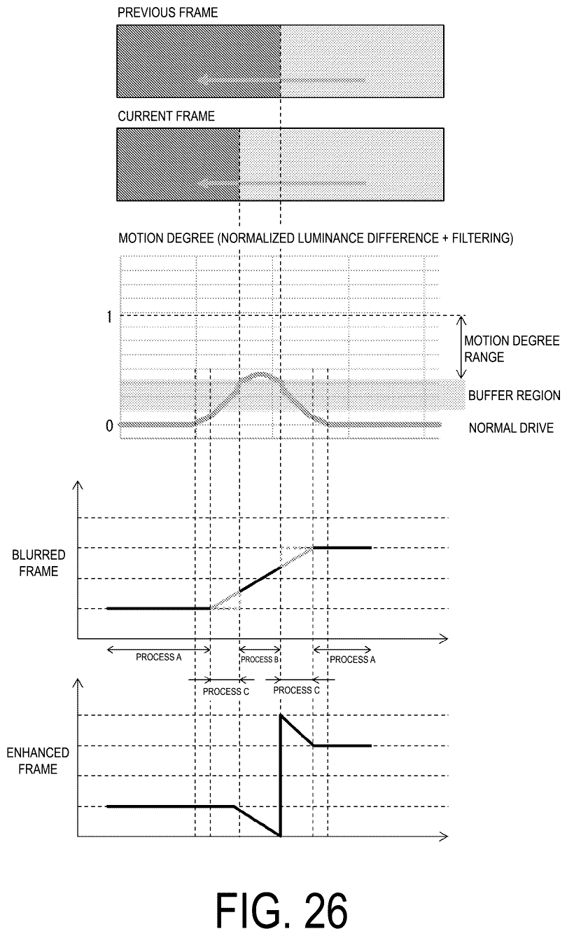

Next, a third embodiment according to the disclosure will be described with reference to FIG. 26. A difference processing unit 5a provided in a display device according to the present embodiment is different from the display devices described in the first and second embodiments in that a motion degree is calculated so as to have 0<motion degree<1 in addition to 1 or 0. The other details are as described in the first and second embodiments. For convenience of description, members having the same functions as those illustrated in the drawings according to the first and second embodiments are denoted by the same reference numerals and signs, and descriptions thereof will be omitted.

FIG. 26 is a diagram illustrating the reason why the degradation of display quality caused by blur processing and enhancement processing can be further suppressed in the display device according to the third embodiment.

In the first and second embodiments described above, a case is described as an example in which the difference processing unit 5a illustrated in FIG. 2 calculates the difference between the image data of the same pixel in the previous frame and the image data of the current frame, as illustrated in FIG. 12, and sets the motion degree to 1 when the difference is not 0, that is, when there is a change in the image data value, or sets the motion degree to 0 when the difference is 0, that is, when there is no change in the image data value, and calculates the motion degree (before filter application) of each pixel corresponding to the previous-current frame difference-based luminance; however, in the present embodiment, the difference processing unit 5a illustrated in FIG. 2 calculates the motion degree to include values of 0<motion degree<1 in addition to 0 and 1.

As illustrated in FIG. 26, in the difference processing unit 5a, the motion degree is calculated such that, in addition to 1 or 0, values of 0<motion degree<1 are also included as a buffer region.

Then, a blur enhancement processing unit 6 illustrated in FIG. 3 outputs image data of a first-half sub-frame and image data of a second-half sub-frame corresponding to pixels where the motion degree is 0 or 1 without performing blur processing and enhancement processing thereon, as in Process A illustrated in FIG. 26. For example, for the image data of the first-half sub-frame and the image data of the second-half sub-frame corresponding to pixels in a first buffer region, where 0<motion degree≤0.1, the blur enhancement processing unit 6 also outputs the data without performing blur processing and enhancement processing thereon, as in Process A illustrated in FIG. 26. For example, for the image data of the first-half sub-frame and the second-half sub-frame corresponding to pixels in a second buffer region, where 0.2<motion degree≤0.3, the blur enhancement processing unit 6 performs blur processing and enhancement processing that reduces luminance thereon, as in Process B illustrated in FIG. 26, and then outputs the image data. Furthermore, for the image data of the first-half sub-frame and the second-half sub-frame corresponding to pixels in a third buffer region, where 0.1<motion degree≤0.2, the blur enhancement processing unit 6 either performs only blur processing thereon without performing enhancement processing thereon and then outputs the data, as in Process C illustrated in FIG. 26, or performs blur processing and enhancement processing that increases luminance thereon and then outputs the image data.

According to the display device of the present embodiment, since the motion degree can be obtained more finely, the degradation of display quality caused by blur processing and enhancement processing can be further suppressed.

### Fourth Embodiment

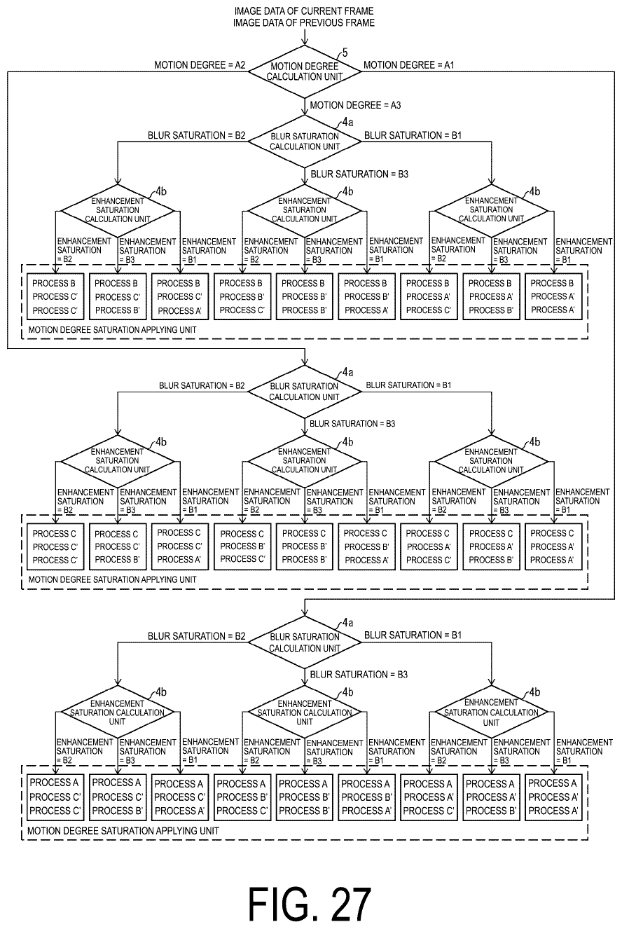

Next, a fourth embodiment according to the disclosure will be described with reference to FIG. 27. An image processing unit 2 provided in a display device according to the present embodiment is different from the display devices described in the first to third embodiments in that the determination criteria for a motion degree, blur saturation, and enhancement saturation are divided into three regions. The others are as described in the first to third embodiments. For convenience of description, members having the same functions as those of the members illustrated in the drawings in the first to third embodiments are denoted by the same reference numerals, and descriptions thereof will be omitted.

FIG. 27 is a diagram illustrating examples of a process of calculating the motion degree, the blur saturation, and the enhancement saturation, and a process of determining the necessity of blur processing and enhancement processing for each pixel based on the calculated values, which are performed in the image processing unit 2 of the display device according to the fourth embodiment.

As illustrated in FIG. 27, in the image processing unit 2 of the display device according to the fourth embodiment, the determination criteria for the motion degree are divided into three regions of an A1 region, an A2 region, and an A3 region, and the determination criteria for the blur saturation and for the enhancement saturation are divided into three regions of a B1 region, a B2 region, and a B3 region.

In FIG. 27, a plurality of processing units indicated by solid lines in a motion degree saturation applying unit indicated by a dotted line each has a top row that illustrates the processing content based on the motion degree, a middle row that illustrates the processing content based on the blur saturation, and a bottom row that illustrates the processing content based on the enhancement saturation.

The processing content based on the motion degree is composed of Process A, Process B, and Process C, as illustrated in FIG. 27. Process A is the process performed on pixels whose motion degree is included in the A1 region, Process B is the process performed on pixels whose motion degree is included in the A3 region, and Process C is the process performed on pixels whose motion degree is included in the A2 region. Process A is the process that outputs image data of a first-half sub-frame and image data of a second-half sub-frame of corresponding pixels without performing blur processing and enhancement processing thereon. Process B is the process that performs blur processing and enhancement processing on the image data of the first-half sub-frame and the image data of the second-half sub-frame of the corresponding pixels and outputs the image data. Process C is the process that calculates the weighted average of blur processing and enhancement processing with the image data of the first-half sub-frame of the current frame for the corresponding pixels and outputs the image data as the image data of the first-half sub-frame of the current frame, and also calculates the weighted average of blur processing and enhancement processing with the image data of the second-half sub-frame of the current frame for the corresponding pixels and outputs the image data as the image data of the second-half sub-frame of the current frame.

As illustrated in FIG. 27, the processing content based on the blur saturation is composed of Process A′, Process B′, and Process C′, where Process A′ is the process performed on pixels whose blur saturation is included in the B1 region, Process B′ is the process performed on pixels whose blur saturation is included in the B3 region, and Process C′ is the process performed on pixels whose blur saturation is included in the B2 region.

As illustrated in FIG. 27, the processing content based on the enhancement saturation is composed of Process A′, Process B′, and Process C′, where Process A′ is the process performed on pixels whose enhancement saturation is included in the B1 region, Process B′ is the process performed on pixels whose enhancement saturation is included in the B3 region, and Process C′ is the process performed on pixels whose blur saturation is included in the B2 region.

Note that, Process A′ is the process that outputs the image data of the first-half sub-frame and the image data of the second-half sub-frame of the corresponding pixels without performing blur processing and enhancement processing thereon. Process B′ is the process that performs blur processing and enhancement processing on the image data of the first-half sub-frame and the image data of the second-half sub-frame of the corresponding pixels and outputs the image data. Process C′ is the process that calculates the weighted average of blur processing and enhancement processing with the image data of the first-half sub-frame of the current frame of the corresponding pixels and outputs the image data as the image data of the first-half sub-frame of the current frame, and also calculates the weighted average of blur processing and enhancement processing with the image data of the second-half sub-frame of the current frame of the corresponding pixels and outputs the image data as the image data of the second-half sub-frame of the current frame.

In each of the plurality of processing units indicated by solid lines provided in the motion degree saturation applying unit indicated by dotted lines in FIG. 27, when Process A is included, Process A is performed on the corresponding pixels, when Process B is included, the processing based on the blur saturation (one of Process A′, Process B′, and Process C′) and the processing based on the enhancement saturation (one of Process A′, Process B′, and Process C′) are performed on the corresponding pixels, and when Process C is included, Process C, or the processing based on the blur saturation (one of Process A′, Process B′, and Process C′) and the processing based on the enhancement saturation (one of Process A′, Process B′, and Process C′) are performed on the corresponding pixels.

According to the display device of the present embodiment, each of the motion degree, the blur saturation, and the enhancement saturation can be obtained more finely, degradation of display quality caused by blur processing and enhancement processing can be further suppressed.

### APPENDIX

The disclosure is not limited to the embodiments described above, and various modifications may be made within the scope of the claims. Embodiments obtained by appropriately combining technical approaches disclosed in the different embodiments also fall within the technical scope of the disclosure. Furthermore, novel technical features can be formed by combining the technical approaches disclosed in the embodiments.

### INDUSTRIAL APPLICABILITY

The disclosure can be utilized for a display device.

### REFERENCE SIGNS LIST

1 Display device
2 Image processing unit
4 Saturation calculation unit
4a Blur saturation calculation unit
4b Enhancement saturation calculation unit
5 Motion degree calculation unit
6 Blur enhancement processing unit
10 Display portion
DU Display unit
RPIX Red pixel
GPIX Green pixel
BPIX Blue pixel
DA Display region
NDA Frame region

1: A display device comprising:
a display portion configured to perform display based on image data of a first-half sub-frame and image data of a second-half sub-frame, image data of a previous frame and image data of a current frame each including brightness data of a plurality of pixels, the image data of the previous frame and the image data of the current frame each being divided into the image data of the first-half sub-frame and the image data of the second-half sub-frame;
a calculation unit including at least one of a motion degree calculation unit configured to calculate a motion degree of the pixels based on the image data of the previous frame and the image data of the current frame, a blur saturation calculation unit configured to calculate blur saturation of the pixels based on the image data of the previous frame and the image data of the current frame, and an enhancement saturation calculation unit configured to calculate enhancement saturation of the pixels based on the image data of the current frame; and
a blur enhancement processing unit configured to perform blur processing on one of the image data of the first-half sub-frame and the image data of the second-half sub-frame of the current frame and perform enhancement processing on the other,
wherein in a case where the calculation unit includes the motion degree calculation unit, the blur enhancement processing unit is configured to output, without performing the blur processing and the enhancement processing on, the image data of the first-half sub-frame and the image data of the second-half sub-frame corresponding to a pixel having the motion degree equal to or less than a first threshold value among the plurality of pixels,
in a case where the calculation unit includes the blur saturation calculation unit, the blur enhancement processing unit is configured to output, without performing the blur processing on, one of the image data of the first-half sub-frame and the image data of the second-half sub-frame corresponding to a pixel having the blur saturation equal to or greater than a second threshold value among the plurality of pixels, and
in a case where the calculation unit includes the enhancement saturation calculation unit, the blur enhancement processing unit is configured to output, without performing the enhancement processing on, one of the image data of the first-half sub-frame and the image data of the second-half sub-frame corresponding to a pixel having the enhancement saturation equal to or greater than the second threshold value among the plurality of pixels.

2: The display device according to claim 1,
wherein the calculation unit includes the motion degree calculation unit, the blur saturation calculation unit, and the enhancement saturation calculation unit,
the motion degree calculation unit is configured to calculate the motion degree of each of the plurality of pixels based on the image data of the previous frame and the image data of the current frame, and
the blur saturation calculation unit and the enhancement saturation calculation unit are configured to respectively calculate the blur saturation and the enhancement saturation only for a pixel having the motion degree greater than the first threshold value among the plurality of pixels.

3: The display device according to claim 1,
wherein the calculation unit includes the motion degree calculation unit, the blur saturation calculation unit, and the enhancement saturation calculation unit,
the blur saturation calculation unit is configured to calculate the blur saturation of each of the plurality of pixels based on the image data of the previous frame and the image data of the current frame,
the enhancement saturation calculation unit is configured to calculate the enhancement saturation of each of the plurality of pixels based on the image data of the current frame, and
the motion degree calculation unit is configured to calculate the motion degree only for a pixel having at least one of the blur saturation and the enhancement saturation less than the second threshold value among the plurality of pixels.

4: The display device according to claim 1,
wherein the motion degree calculation unit includes a difference processing unit,
the difference processing unit is configured to calculate a difference between the brightness data of the image data of the previous frame and the brightness data of the image data of the current frame at an identical pixel among the plurality of pixels, and
the motion degree is calculated based on the difference calculated by the difference processing unit.

5: The display device according to claim 1,
wherein the calculation unit includes a normalized luminance calculation unit and a saturation processing unit,
the normalized luminance calculation unit is configured to calculate normalized luminance data of the image data of the previous frame based on the brightness data of the image data of the previous frame and to calculate normalized luminance data of the image data of the current frame based on the brightness data of the image data of the current frame,
the saturation processing unit is configured to convert each of a value of the normalized luminance data of the image data of the previous frame and a value of the normalized luminance data of the image data of the current frame into 0 in a case where each of the values is equal to or greater than a third threshold value and equal to or less than a fourth threshold value, and to convert each of the values into 1 in a case where each of the values is less than the third threshold value or greater than the fourth threshold value, and
each of the blur saturation and the enhancement saturation is calculated based on the converted values obtained by the saturation processing unit.

6: The display device according to claim 1,
wherein the calculation unit includes a normalized luminance calculation unit and a saturation processing unit,
the normalized luminance calculation unit is configured to calculate normalized luminance data of the image data of the previous frame based on the brightness data of the image data of the previous frame and to calculate normalized luminance data of the image data of the current frame based on the brightness data of the image data of the current frame,
the saturation processing unit is configured to convert each of a value of the normalized luminance data of the image data of the previous frame and a value of the normalized luminance data of the image data of the current frame into 0 in a case where each of the values is equal to or greater than a fifth threshold value and equal to or less than a sixth threshold value, to convert each of the values into a value greater than 0 and less than 1 in a case where each of the values is less than the fifth threshold value and equal to or greater than a seventh threshold value or in a case where each of the values is greater than the sixth threshold value and equal to or less than an eighth threshold value, and to convert each of the values into 1 in a case where each of the values is less than the seventh threshold value or greater than the eighth threshold value, and
each of the blur saturation and the enhancement saturation is calculated based on the converted values obtained by the saturation processing unit.

7: The display device according to claim 1,
wherein the brightness data is a gray scale value.

8: The display device according to claim 1,
wherein the brightness data is a Y luminance value in YUV data.

9: The display device according to claim 5,
wherein the brightness data is a gray scale value,
the normalized luminance data is composed of values each being equal to or greater than 0 and equal to or less than 1, the values being calculated by (gray scale value/maximum gray scale value)^{2.2},
the third threshold value is 0.1, and
the fourth threshold value is 0.6.

10: The display device according to claim 6,
wherein the brightness data is a gray scale value,
the normalized luminance data is composed of values each being equal to or greater than 0 and equal to or less than 1, the values being calculated by (gray scale value/maximum gray scale value)^{2.2},
the fifth threshold value is 0.2,
the sixth threshold value is 0.6,
the seventh threshold value is 0.1, and
the eighth threshold value is 0.9.

11: The display device according to claim 5,
wherein the brightness data is a Y luminance value in YUV data,
the normalized luminance data is composed of values each being equal to or greater than 0 and equal to or less than 1, the values being calculated by (Y luminance value/maximum Y luminance value)^{2.2},
the third threshold value is 0.1, and
the fourth threshold value is 0.6.

12: The display device according to claim 6,
wherein the brightness data is a Y luminance value in YUV data,
the normalized luminance data is composed of values each being equal to or greater than 0 and equal to or less than 1, the values being calculated by (Y luminance value/maximum Y luminance value)^{2.2},
the fifth threshold value is 0.2,
the sixth threshold value is 0.6,
the seventh threshold value is 0.1, and
the eighth threshold value is 0.9.

13: The display device according to claim 1,
wherein each of the plurality of pixels of the display portion includes a light-emitting element including an organic light-emitting layer.

14: The display device according to claim 1,
wherein each of the plurality of pixels of the display portion includes a light-emitting element including a light-emitting layer including quantum dots.
